(19) United States
(12) Patent Application Publication
(10) Pub. No.: US 2020/0117105 A1
(43) Pub. Date: Apr. 16, 2020

(54) IMAGE FORMING APPARATUS AND PROCESS CARTRIDGE

(71) Applicant: FUJI XEROX CO., LTD., Tokyo (JP)

(72) Inventors: Takuya WATANABE, Kanagawa (JP); Takeshi KAWAI, Kanagawa (JP)

(73) Assignee: FUJI XEROX CO., LTD., Tokyo (JP)

(21) Appl. No.: 16/379,898

(22) Filed: Apr. 10, 2019

(30) Foreign Application Priority Data
Oct. 12, 2018 (JP) 2018-193591

(51) Int. Cl. G03G 5/05; G03G 5/06; G03G 5/07

(52) U.S. Cl. CPC G03G 5/0525; G03G 5/071; G03G 5/0662

(57) ABSTRACT

An image forming apparatus includes an electrophotographic photoreceptor including a conductive substrate, an undercoat layer containing a binder resin and metal oxide particles, disposed on the conductive substrate, and a photosensitive layer disposed on the undercoat layer; a charging unit that charges a surface of the electrophotographic photoreceptor; an electrostatic latent image-forming unit forming an electrostatic latent image on the charged surface of the electrophotographic photoreceptor; a developing unit developing the electrostatic latent image on the surface of the electrophotographic photoreceptor by using a developer containing a toner to form a toner image; and a transfer unit that transfers the toner image onto a surface of a transfer-receiving member, but not including a charge erasing member that erases charges on the surface of the electrophotographic photoreceptor. The photosensitive layer formed is 3.8% or more and 17% or less to a carbon element abundance determined by X-ray photoelectron spectroscopy.

### CROSS-REFERENCE TO RELATED APPLICATIONS

This application is based on and claims priority under 35 USC 119 from Japanese Patent Application No. 2018-193591 filed Oct. 12, 2018.

### BACKGROUND

### (i) Technical Field

The present disclosure relates to an image forming apparatus and a process cartridge.

### (ii) Related Art

Japanese Unexamined Patent Application Publication No. 07-013388 discloses an “original plate for electrophotographic planography, the original plate including a paper support and a photoconductive layer on the paper support, the photoconductive layer containing a resin binder and a photoconductive substance containing at least zinc oxide, in which the percentage of exposed zinc oxide on the surface of the photoconductive layer is in the range of 2.1% to 5%.

### SUMMARY

An image forming apparatus not equipped with a charge erasing member that erases charges on the surface of an electrophotographic photoreceptor (such an image forming apparatus may be hereinafter referred to as a “particular image forming apparatus”) has a tendency to undergo an afterimage phenomenon in which the history of a previous image remains (hereinafter this phenomenon is referred to as “ghost”), and image density non-uniformity.

Aspects of non-limiting embodiments of the present disclosure relate to an image forming apparatus with which occurrence of ghost is suppressed compared to an electrophotographic photoreceptor that includes an undercoat layer in which a metal element abundance ratio determined by X-ray photoelectron spectroscopy at a surface of the undercoat layer on which the photosensitive layer is formed is less than 3.8% relative to a carbon element abundance determined by X-ray photoelectron spectroscopy at the surface of the undercoat layer on which the photosensitive layer is formed, and with which occurrence of image density non-uniformity is suppressed compared to an image forming apparatus that includes an undercoat layer in which the metal element abundance ratio is more than 17%.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including an electrophotographic photoreceptor including a conductive substrate, an undercoat layer containing a binder resin and metal oxide particles and being disposed on the conductive substrate, and a photosensitive layer disposed on the undercoat layer; a charging unit that charges a surface of the electrophotographic photoreceptor; an electrostatic latent image-forming unit that forms an electrostatic latent image on the charged surface of the electrophotographic photoreceptor; a developing unit that develops the electrostatic latent image on the surface of the electrophotographic photoreceptor by using a developer containing a toner so as to form a toner image; and a transfer unit that transfers the toner image onto a surface of a transfer-receiving member, but not including a charge erasing member that erases charges on the surface of the electrophotographic photoreceptor. A metal element abundance ratio determined by X-ray photoelectron spectroscopy at a surface of the undercoat layer on which the photosensitive layer is formed is 3.8% or more and 17% or less relative to the carbon element abundance determined by X-ray photoelectron spectroscopy at the surface of the undercoat layer on which the photosensitive layer is formed.

### BRIEF DESCRIPTION OF THE DRAWINGS

Exemplary embodiments of the present disclosure will be described in detail based on the following figures, wherein:

FIG. 1 is a schematic cross-sectional view illustrating one example of an image forming apparatus according to an exemplary embodiment;

FIG. 2 is a schematic perspective view illustrating another example of the image forming apparatus according to the exemplary embodiment; and

FIG. 3 is a schematic perspective view illustrating an example of a layer structure of an electrophotographic photoreceptor of the image forming apparatus of the exemplary embodiment.

### DETAILED DESCRIPTION

In this description, when an amount of a component in a composition is referred and when there are more than one substance that corresponds to that component in the composition, the amount of that component is the total amount of more than one substance present in the composition unless otherwise noted.

The exemplary embodiments of the present disclosure will now be described.

### Image Forming Apparatus (and Process Cartridge)

An image forming apparatus of an exemplary embodiment includes an electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image on the surface of the electrophotographic photoreceptor by using a developer containing a toner so as to form a toner image, and a transfer unit that transfers the toner image onto a surface of a recording medium, but does not include a charge erasing member that erases charges on the surface of the electrophotographic photoreceptor.

The electrophotographic photoreceptor of this exemplary embodiment includes a conductive substrate, an undercoat layer disposed on the conductive substrate and containing a binder resin and metal oxide particles, and a photosensitive layer on the undercoat layer. The metal element abundance ratio determined by X-ray photoelectron spectroscopy at a surface of the undercoat layer on which the photosensitive layer is formed is 3.8% or more and 17% or less relative to the carbon element abundance determined by X-ray photoelectron spectroscopy at the surface of the undercoat layer on which the photosensitive layer is formed.

The image forming apparatus of the exemplary embodiment is applied to a known image forming apparatus, examples of which include an apparatus equipped with a fixing unit that fixes the toner image transferred onto the surface of the recording medium; a direct transfer type apparatus with which the toner image formed on the surface of the electrophotographic photoreceptor is directly transferred to the recording medium; an intermediate transfer type apparatus with which the toner image formed on the surface of the electrophotographic photoreceptor is first transferred to a surface of an intermediate transfer body and then the toner image on the surface of the intermediate transfer body is transferred to the surface of the recording medium; an apparatus equipped with a cleaning unit that cleans the surface of the electrophotographic photoreceptor after the toner image transfer and before charging; and an apparatus equipped with an electrophotographic photoreceptor heating member that elevates the temperature of the electrophotographic photoreceptor to reduce the relative temperature.

In the intermediate transfer type apparatus, the transfer unit includes, for example, an intermediate transfer body having a surface onto which a toner image is to be transferred, a first transfer unit that conducts first transfer of the toner image on the surface of the electrophotographic photoreceptor onto the surface of the intermediate transfer body, and a second transfer unit that conducts second transfer of the toner image on the surface of the intermediate transfer body onto a surface of a recording medium.

The image forming apparatus of this exemplary embodiment may be of a dry development type or a wet development type (development type that uses a liquid developer).

In the image forming apparatus of the exemplary embodiment, for example, a section that includes the electrophotographic photoreceptor may be configured as a cartridge structure (process cartridge) detachably attachable to the image forming apparatus.

In other words, the process cartridge of this embodiment detachably attachable to an image forming apparatus is equipped with an electrophotographic photoreceptor that includes a conductive substrate, an undercoat layer disposed on the conductive substrate, and a photosensitive layer disposed on the undercoat layer, in which the metal element abundance ratio determined by X-ray photoelectron spectroscopy at a surface of the undercoat layer on which the photosensitive layer is formed is 3.8% or more and 17% or less relative to the carbon element abundance determined by X-ray photoelectron spectroscopy at the surface of the undercoat layer on which the photosensitive layer is formed. However, the process cartridge is not equipped with a charge erasing member that erases charges on the surface of the electrophotographic photoreceptor. The process cartridge may be equipped with, in addition to the electrophotographic photoreceptor, at least one selected from the group consisting of a charging unit, an electrostatic latent image forming unit, a developing unit, and a transfer unit, for example.

Electrophotographic image forming apparatuses in recent years have faced growing demand for improved performance, such as higher speed and higher image quality, as well as environmental load reduction, size reduction, and lower prices. In order to meet such demand, a system that does not include a charge erasing member that erases potential differences on the surface of the electrophotographic photoreceptor after a toner image is transferred onto a transfer-receiving member by a transfer unit and before the surface of an electrophotographic photoreceptor is charged by a charging unit is increasingly employed in image forming apparatuses.

In an electrophotographic image forming apparatus, application of a reverse bias in the transfer step causes electrostatic force that acts from the photoreceptor surface toward a transfer unit works on the toner image, and the toner image on the photoreceptor surface is transferred onto a transfer-receiving member. In the photoreceptor surface after the toner image transfer, differences in residual potential occur between regions where the toner image has been present and regions where the toner image has not been present. In particular, an image forming apparatus (particular image forming apparatus) not equipped with a charge erasing member that erases charges on the surface of the electrophotographic photoreceptor tends to undergo ghost when images are formed. Occurrence of ghost is probably attributable to accumulation of charges at the interface between the undercoat layer and the photosensitive layer.

In contrast, the particular image forming apparatus of this exemplary embodiment can suppress occurrence of ghost due to the aforementioned features. The cause for this is not clear, but can be presumed to be as follows.

According to the undercoat layer of this exemplary embodiment, the metal element abundance ratio determined by X-ray photoelectron spectroscopy at a surface of the undercoat layer on which the photosensitive layer is formed is 3.8% or more relative to the carbon element abundance determined by X-ray photoelectron spectroscopy at the surface of the undercoat layer on which the photosensitive layer is formed. In other words, the thickness of the binder resin that covers the metal oxide particles present on the surface layer of the undercoat layer tends to be small compared to the undercoat layer of related art. As the thickness of the binder resin that covers the metal oxide particles present on the surface layer of the undercoat layer decreases, the energy barrier at the interface between the undercoat layer and the photosensitive layer tends decrease. Thus, accumulation of the charges at the interface between the undercoat layer and the photosensitive layer tends to be suppressed. Presumably as a result, occurrence of ghost is suppressed.

Meanwhile, at an excessively high metal element abundance ratio, image density non-uniformity may occur. Thus, the metal element abundance ratio of the undercoat layer of the exemplary embodiment is to be 17% or less relative to the carbon element abundance so that the metal oxide particles are not excessively present and tend not to agglomerate on the surface layer of the undercoat layer. Presumably as a result, occurrence of image density non-uniformity is suppressed.

Although some examples of the image forming apparatus of an exemplary embodiment are described below, these examples are not limiting. Only relevant sections illustrated in the drawings are described, and descriptions of other sections are omitted.

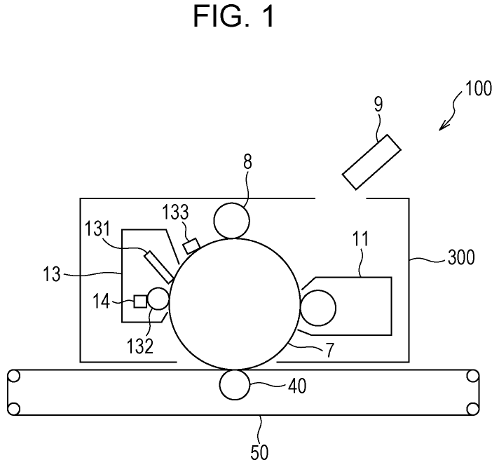

FIG. 1 is a schematic diagram illustrating one example of an image forming apparatus according to an exemplary embodiment.

As illustrated in FIG. 1, an image forming apparatus 100 of this exemplary embodiment includes a process cartridge 300 that includes an electrophotographic photoreceptor 7, an exposing device 9 (one example of the electrostatic latent image forming unit), a transfer device 40 (first transfer device), and an intermediate transfer body 50. In this image forming apparatus 100, the exposing device 9 is positioned so that light can be applied to the electrophotographic photoreceptor 7 from the opening in the process cartridge 300, the transfer device 40 is positioned to oppose the electrophotographic photoreceptor 7 with the intermediate transfer body 50 therebetween, and the intermediate transfer body 50 has a portion contacting the electrophotographic photoreceptor 7. Although not illustrated in the drawings, a second transfer device that transfers the toner image on the intermediate transfer body 50 onto a recording medium (for example, a paper sheet) is also provided. The intermediate transfer body 50, the transfer device 40 (first transfer unit), and a second transfer device (not illustrated) correspond to examples of the transfer unit.

The process cartridge 300 illustrated in FIG. 1 integrates and supports the electrophotographic photoreceptor 7, the charging device 8 (one example of the charging unit), the developing device 11 (one example of the developing unit), and the cleaning device 13 (one example of the cleaning unit) in the housing. The cleaning device 13 has a cleaning blade (one example of the cleaning member) 131, and the cleaning blade 131 is in contact with the surface of the electrophotographic photoreceptor 7. The cleaning member need not take a form of the cleaning blade 131, and may be a conductive or insulating fibrous member which can be used alone or in combination with the cleaning blade 131.

In FIG. 1, an image forming apparatus equipped with a fibrous member 132 (roll) that supplies a lubricant 14 to the surface of the electrophotographic photoreceptor 7 and a fibrous member 133 (flat brush) that assists cleaning is illustrated as an example, but these components are optional.

The features of the image forming apparatus of this exemplary embodiment will now be described.

### Charging Device

Examples of the charging device 8 include contact-type chargers that use conductive or semi-conducting charging rollers, charging brushes, charging films, charging rubber blades, and charging tubes. Known chargers such as non-contact-type roller chargers, and scorotron chargers and corotron chargers that utilize corona discharge are also be used.

### Exposing Device

Examples of the exposing device 9 include optical devices that can apply light, such as semiconductor laser light, LED light, or liquid crystal shutter light, into a particular image shape onto the surface of the electrophotographic photoreceptor 7. The wavelength of the light source is to be within the spectral sensitivity range of the electrophotographic photoreceptor. The mainstream wavelength of the semiconductor lasers is near infrared having an oscillation wavelength at about 780 nm. However, the wavelength is not limited to this, and a laser having an oscillation wavelength on the order of 600 nm or a blue laser having an oscillation wavelength of 400 nm or more and 450 nm or less may be used. In order to form a color image, a surface-emitting laser light source that can output multi beams is also effective.

### Developing Device

Examples of the developing device 11 include common developing devices that perform development by using a developer in contact or non-contact manner. The developing device 11 is not particularly limited as long as the aforementioned functions are exhibited, and is selected according to the purpose. An example thereof is a known developer that has a function of attaching a one-component developer or a two-component developer to the electrophotographic photoreceptor 7 by using a brush, a roller, or the like. In particular, a development roller that retains the developer on its surface may be used.

The developer used in the developing device 11 may be a one-component developer that contains only a toner or a two-component developer that contains a toner and a carrier. The developer may be magnetic or non-magnetic. Any known developers may be used as these developers.

### Cleaning Device

A cleaning blade type device equipped with a cleaning blade 131 is used as the cleaning device 13.

Instead of the cleaning blade type, a fur brush cleaning type device or a development-cleaning simultaneous type device may be employed.

### Transfer Device

Examples of the transfer device 40 include contact-type transfer chargers that use belts, rollers, films, rubber blades, etc., and known transfer chargers such as scorotron transfer chargers and corotron transfer chargers that utilize corona discharge.

### Intermediate Transfer Body

A belt-shaped member (intermediate transfer belt) that contains semi-conducting polyimide, polyamide imide, polycarbonate, polyarylate, a polyester, a rubber or the like is used as the intermediate transfer body 50. The form of the intermediate transfer body other than the belt may be a drum.

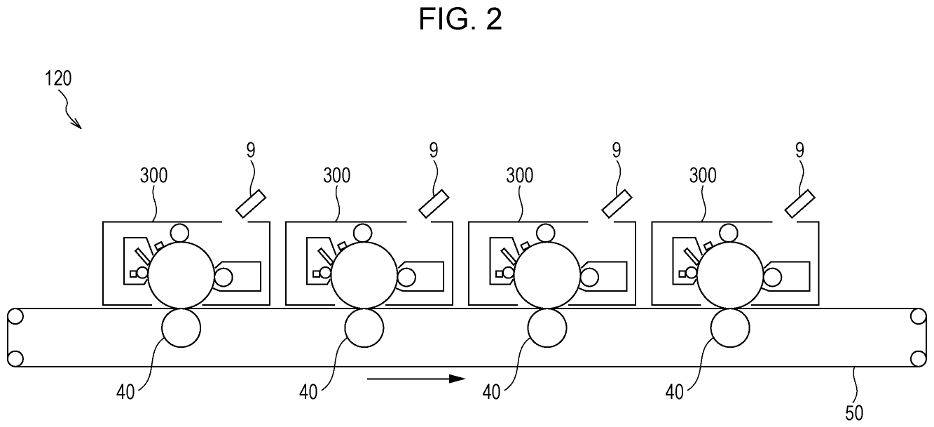

FIG. 2 is a schematic diagram illustrating another example of the image forming apparatus according to this exemplary embodiment.

An image forming apparatus 120 illustrated in FIG. 2 is a tandem-system multicolor image forming apparatus equipped with four process cartridges 300. In the image forming apparatus 120, four process cartridges 300 are arranged in parallel on the intermediate transfer body 50, and one electrophotographic photoreceptor is used for one color. The image forming apparatus 120 is identical to the image forming apparatus 100 except for the tandem system.

In the description below, the layer structure of the electrophotographic photoreceptor of this exemplary embodiment is described.

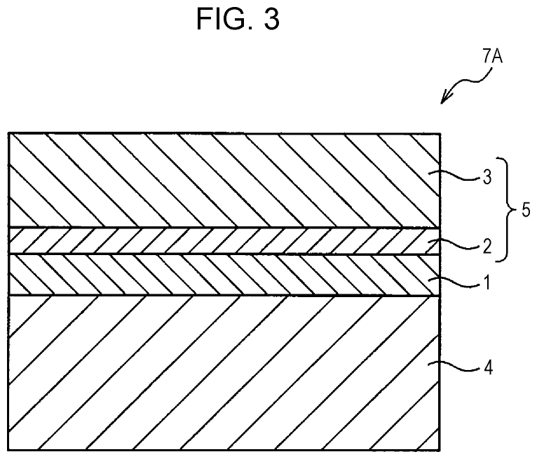

FIG. 3 is a schematic partial cross-sectional view of one example of the layer structure of an electrophotographic photoreceptor applied to the image forming apparatus of this exemplary embodiment. An electrophotographic photoreceptor 7A illustrated in FIG. 3 has a structure in which an undercoat layer 1, a charge generating layer 2, and a charge transporting layer 3 are stacked in this order on a conductive substrate 4. The charge generating layer 2 and the charge transporting layer 3 constitute a photosensitive layer 5. The electrophotographic photoreceptor 7A may have other layers as needed. Examples of other layers include a protective layer formed on an outer circumferential surface of the charge transporting layer 3. The electrophotographic photoreceptor applied to the image forming apparatus of this exemplary embodiment is not limited to the structure illustrated in FIG. 3, and the photosensitive layer may be a single-layer-type photosensitive layer.

In the description below, the respective layers of the electrophotographic photoreceptor of this exemplary embodiment are described in detail. In the description below, the reference signs are omitted.

### Electrophotographic Photoreceptor

The electrophotographic photoreceptor of this exemplary embodiment includes a conductive substrate, an undercoat layer disposed on the conductive substrate and containing a binder resin and metal oxide particles, and a photosensitive layer on the undercoat layer.

### Undercoat Layer

The undercoat layer of this exemplary embodiment is disposed on the conductive substrate and contains a binder resin and metal oxide particles. The undercoat layer may further contain an electron-accepting compound and other additives.

### Properties of Undercoat Layer

With this undercoat layer, the lower limit value of the metal element abundance ratio determined by X-ray photoelectron spectroscopy at a surface on which the photosensitive layer is formed is 3.8% or more, preferably 4.0% or more, and more preferably 5.0% or more relative to the carbon element abundance determined by X-ray photoelectron spectroscopy at the surface of the undercoat layer on which the photosensitive layer is formed.

The metal element abundance ratio at the surface of the undercoat layer on which the photosensitive layer is formed refers to the abundance ratio of the metal elements contained in metal oxide particles present on the surface layer of the undercoat layer.

When the lower limit of the metal element abundance ratio is 3.8% or more relative to the carbon element abundance, the thickness of the binder resin that covers the metal oxide particles present on the surface layer of the undercoat layer tends to be small. Thus, the energy barrier at the interface between the undercoat layer and the photosensitive layer tends to be small. Presumably as a result, occurrence of ghost is suppressed.

In this undercoat layer, from the viewpoint of suppressing the image density non-uniformity, the upper limit of the metal element abundance ratio determined by X-ray photoelectron spectroscopy at a surface on which the photosensitive layer is formed is 17% or less, preferably 15.5% or less, and more preferably 15% or less relative to the carbon element abundance determined by X-ray photoelectron spectroscopy at the surface of the undercoat layer on which the photosensitive layer is formed.

The metal element abundance ratio determined by X-ray photoelectron spectroscopy (XPS) measurement at the surface of the undercoat layer on which the photosensitive layer is formed is determined as follows.

(1) The XPS measurement on the surface of the undercoat layer involves removing the layers (such as a photosensitive layer) on the outer circumferential surface of the undercoat layer of the electrophotographic photoreceptor by using a cutter or the like or by dissolution in a solvent or the like.
(2) The undercoat layer is cut into 2.0 cm×2.0 cm, and the surface of the undercoat layer on which the photosensitive layer is formed is measured under the following conditions.

### Conditions for XPS Measurement

X-ray photoelectron spectroscope: PHI 5000 VersaProbe produced by ULVAC, Inc.

X-ray: 100 μmΦ

### Measurement Area: 300 μm Square

(3) From the measurement result, the peak area derived from the metal element is determined and assumed to be the metal element abundance.
(4) From the measurement result, the peak area derived from the carbon element is determined and assumed to be the carbon element abundance.
(5) Metal element abundance ratio (%)=(peak area of metal element)/((peak area of metal element)+(peak area of carbon element))×100.
(6) The methods (1) to (5) described above are performed on the undercoat layer at three different positions in the photoreceptor, and the arithmetic mean of the obtained metal element abundance ratios is assumed to be the metal element abundance ratio.

When peaks of two or more metal elements, for example, M1 element and M2 element, are detected and it can be determined that two or more metal elements are contained, the total of the area of the metal elements (peak area of M1 element+peak area of M2 element) is assumed to be the peak area of the metal element.

Examples of the technique for adjusting the metal element abundance ratio determined by X-ray photoelectron spectroscopy at the surface of the undercoat layer on which the photosensitive layer is formed so that the ratio is within the aforementioned range include adjusting the time for dispersing metal oxide particles in a resin particle dispersion during the undercoat layer-forming solution preparation step, and adjusting the metal oxide particle content relative to the binder resin.

The thickness of the undercoat layer is preferably 15 μm or more and 50 μm or less, more preferably 15 μm or more and 35 μm or less, and yet more preferably 15 μm or more and 25 μm or less.

The thickness of the undercoat layer is measured by using SR-SCOPE (registered trademark) RMP30-S produced by Fischer Instruments K.K.

The volume resistivity of the undercoat layer is preferably 1.0×10⁴ (Ω·m) or more and 10×10¹⁰ (Ω·m) or less, more preferably 1.0×10⁶ (Ω·m) or more and 10×10⁸ (Ω·m) or less, and yet more preferably 1.0×10⁶ (Ω·m) or more and 10×10⁷ (Ω·m) or less.

An undercoat layer sample for volume resistivity measurement is prepared from the electrophotographic photoreceptor as follows. For example, coating films, such as a charge generating layer and a charge transporting layer, that cover the undercoat layer are removed with a solvent, such as acetone, tetrahydrofuran, methanol, or ethanol, and a gold electrode is attached to the exposed undercoat layer by a vacuum vapor deposition method, a sputtering method, or the like to prepare an undercoat layer sample for volume resistivity measurement.

When measuring the volume resistivity by an AC impedance method, SI 1287 electrochemical interface (produced by TOYO Corporation) is used as a power supply, SI 1260 impedance/gain phase analyzer (TOYO Corporation) is used as a current meter, and 1296 dielectric interface (produced by TOYO Corporation) is used as a current amplifier.

An AC voltage of 1 Vp-p is applied to the AC impedance measurement sample having an aluminum substrate serving as a cathode and a gold electrode serving as an anode over a frequency range of 1 MHz to 1 mHz from the high frequency side so as to measure the AC impedance of each sample, and a Cole-Cole plot graph obtained by the measurement is fitted with an RC parallel equivalent circuit to calculate the volume resistivity.

The undercoat layer may have a Vickers hardness of 35 or more.

In order to suppress moire images, the surface roughness (ten-point average roughness) of the undercoat layer may be adjusted to be in the range of 1/(4n) (n represents the refractive index of the overlying layer) to ½ of λ representing the laser wavelength used for exposure.

In order to adjust the surface roughness, binder resin particles and the like may be added to the undercoat layer. Examples of the binder resin particles include silicone binder resin particles and crosslinking polymethyl methacrylate binder resin particles. The surface of the undercoat layer may be polished to adjust the surface roughness. Examples of the polishing method included buff polishing, sand blasting, wet honing, and grinding. Binder resin

The undercoat layer contains a binder resin. The undercoat layer may be a layer formed of a cured film (including a crosslinked film) prepared by curing a binder resin.

Examples of the binder resin used in the undercoat layer include thermosetting polymer compounds such as polyimide, guanamine resins, urethane resins, epoxy resins, phenolic resins, urea resins, melamine resins, unsaturated polyester resins, diallyl phthalate resins, alkyd resins, polyaminobismaleimide, furan resins, and phenol-formaldehyde resins.

Among these, the binder resin may be at least one selected from the group consisting of guanamine resins, polyimide, urethane resins, epoxy resins, phenolic resins, urea resins, and melamine resins, or may be at least one selected from the group consisting of phenolic resins, melamine resins, guanamine resins, and urethane resins. When two or more of these binder resins are used in combination, the mixing ratios may be set as necessary.

The binder resin may use a curing agent, such as a polyfunctional epoxy compound or a polyfunctional isocyanate compound.

Examples of the polyfunctional epoxy compound that can be used include polyfunctional epoxy derivatives such as diglycidyl ether compounds, triglycidyl ether compounds, and tetraglycidyl ether compounds, and haloepoxy compounds. Specific examples thereof include glycidyl ether compounds of polyhydric alcohols such as ethylene glycol diglycidyl ether, polyethylene glycol diglycidyl ether, propylene glycol diglycidyl ether, polypropylene glycol diglycidyl ether, glyceryl diglycidyl ether, and glyceryl triglycidyl ether; glycidyl ether compounds of aromatic polyhydric phenols, such as bisphenol A diglycidyl ether; and haloepoxy compounds such as epichlorohydrin, epibromohydrin, and β-methylepichlorohydrin.

The polyfunctional isocyanate compound may have three or more isocyanate groups, and specific examples thereof include polyisocyanate monomers such as 1,3,6-hexamethylene triisocyanate, lysine ester triisocyanate, 1,6,11-undecane triisocyanate, 1,8-isocyanate-4-isocyanatomethyloctane, triphenylmethane triisocyanate, and tris(isocyanatophenyl) thiophosphate. From the viewpoint of film formation properties, crack generation properties, and handling ease of the crosslinked film obtained as a final product, modified products, such as derivatives and prepolymers obtained from polyisocyanate monomers, may be used among the compounds having three or more isocyanate groups.

Examples thereof include a urethane modified product obtained by modifying a polyol with the trifunctional isocyanate compound in excess, a biuret modified product obtained by modifying a compound having a urea bond with an isocyanate compound, and an allophanate modified product obtained by adding isocyanates to a urethane group. Other examples include isocyanurate modified products and carbodiimide modified products.

The total binder resin content in the exemplary embodiment relative to the total solid content in the undercoat layer is preferably 20 mass % or more and 70 mass % or less and more preferably 20 mass % or more and 40 mass % or less.

### Metal Oxide Particles

The undercoat layer contains metal oxide particles.

An example of the metal oxide particles is inorganic particles having a powder resistance (volume resistivity) of 10² Ω·cm or more and 10¹¹ Ω·cm or less. Examples of the metal oxide particles having this resistance value include metal oxide particles such as zinc oxide particles, titanium oxide particles, tin oxide particles, and zirconium oxide particles.

The undercoat layer may contain at least one type of metal oxide particles selected from the group consisting of zinc oxide particles, titanium oxide particles, and tin oxide particles. The undercoat layer more preferably contains zinc oxide particles.

The specific surface area of the metal oxide particles measured by the BET method may be, for example, 10 m²/g or more.

The volume-average particle diameter of the metal oxide particles may be, for example, 50 nm or more and 2000 nm or less (or may be 60 nm or more and 1000 nm or less).

The metal oxide particle content relative to the total solid content in the undercoat layer is preferably 10 mass % or more and 85 mass % or less, more preferably 30 mass % or more and 80 mass % or less, and yet more preferably 60 mass % or more and 80 mass % or less.

The metal oxide particles may be surface-treated. A mixture of two or more metal oxide particles subjected to different surface treatments or having different particle diameters may be used.

Examples of the surface treatment agent include a silane coupling agent, a titanate-based coupling agent, an aluminum-based coupling agent, and a surfactant. In particular, a silane coupling agent may be used, and an amino-group-containing silane coupling agent may be used.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, an amino-group-containing silane coupling agent may be used in combination with an additional silane coupling agent. Examples of this additional silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxy silane, 3-aminopropyltriethoxysilane, N-2- (aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method that uses a surface treatment agent may be any known method, for example, may be a dry method or a wet method.

The treatment amount of the surface treatment agent may be, for example, 0.5 mass % or more and 10 mass % or less relative to the inorganic particles.

### Electron-Accepting Compound

The electron-accepting compound may be dispersed in the undercoat layer along with the metal oxide particles, or may be attached to the surfaces of the metal oxide particles. When the electron-accepting compound is contained while attaching to the surfaces of the metal oxide particles, the electron-accepting compound may be a material that chemically reacts with the surfaces of the metal oxide particles or a material that adsorbs to the surfaces of the metal oxide particles, and the electron-accepting compound can be selectively present on the surfaces of the metal oxide particles.

Examples of the electron-accepting compound include electron-accepting compounds having skeletons such as a quinone skeleton, an anthraquinone skeleton, a coumarin skeleton, a phthalocyanine skeleton, a triphenylmethane skeleton, an anthocyanin skeleton, a flavone skeleton, a fullerene skeleton, a ruthenium complex skeleton, a xanthene skeleton, a benzoxazine skeleton, and a porphyrin skeleton.

The electron-accepting compound may be a compound in which such a skeleton is substituted with a substituent such as an acidic group (for example, a hydroxyl group, a carboxyl group, or a sulfonyl group), an aryl group, or an amino group.

In particular, from the viewpoint of adjusting the electrostatic capacitance of the undercoat layer per unit area to be within the range described above, the electron-accepting compound may be an electron-accepting compound having an anthraquinone skeleton or may be an electron-accepting compound having a hydroxyanthraquinone skeleton (an anthraquinone skeleton having a hydroxyl group) in particular.

Specific examples of the electron-accepting compound having a hydroxyanthraquinone skeleton include compounds represented by general formula (1) below.

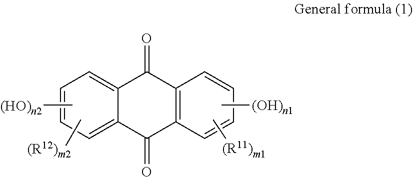

In general formula (1), n1 and n2 each independently represent an integer of 0 or more and 3 or less. However, at least one of n1 and n2 represents an integer of 1 or more and 3 or less (in other words, n1 and n2 do not simultaneously represent 0). In addition, m1 and m2 each independently represent an integer of 0 or 1. R¹¹ and R¹² each independently represent an alkyl group having 1 to 10 carbon atoms or an alkoxy group having 1 to 10 carbon atoms.

The electron-accepting compound may be a compound represented by general formula (2) below.

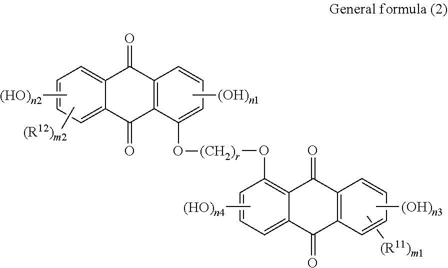

In general formula (2), n1, n2, n3, and n4 each independently represent an integer of 0 or more and 3 or less. In addition, m1 and m2 each independently represent an integer of 0 or 1. Moreover, at least one of n1 and n2 represents an integer of 1 or more and 3 or less (in other words, n1 and n2 do not simultaneously represent 0). Moreover, at least one of n3 and n4 represents an integer of 1 or more and 3 or less (in other words, n3 and n4 do not simultaneously represent 0). Furthermore, r represents an integer of 2 or more and 10 or less. R¹¹ and R¹² each independently represent an alkyl group having 1 to 10 carbon atoms or an alkoxy group having 1 to 10 carbon atoms.

The alkyl groups having 1 to 10 carbon atoms represented by R¹¹ and R¹² in general formulae (1) and (2) may be linear or branched, and examples thereof include a methyl group, an ethyl group, a propyl group, and an isopropyl group. The alkyl group having 1 to 10 carbon atoms may be an alkyl group having 1 to 8 carbon atoms or an alkyl group having 1 to 6 carbon atoms.

The alkoxy groups (alkoxyl groups) having 1 to 10 carbon atoms represented by R¹¹ and R¹² may be linear or branched, and examples thereof include a methoxy group, an ethoxy group, a propoxy group, and an isopropoxy group. The alkoxy group having 1 to 10 carbon atoms may be an alkoxy group having 1 to 8 carbon atoms or an alkoxy group having 1 to 6 carbon atoms.

Non-limiting specific examples of the electron-accepting compound are as follows.

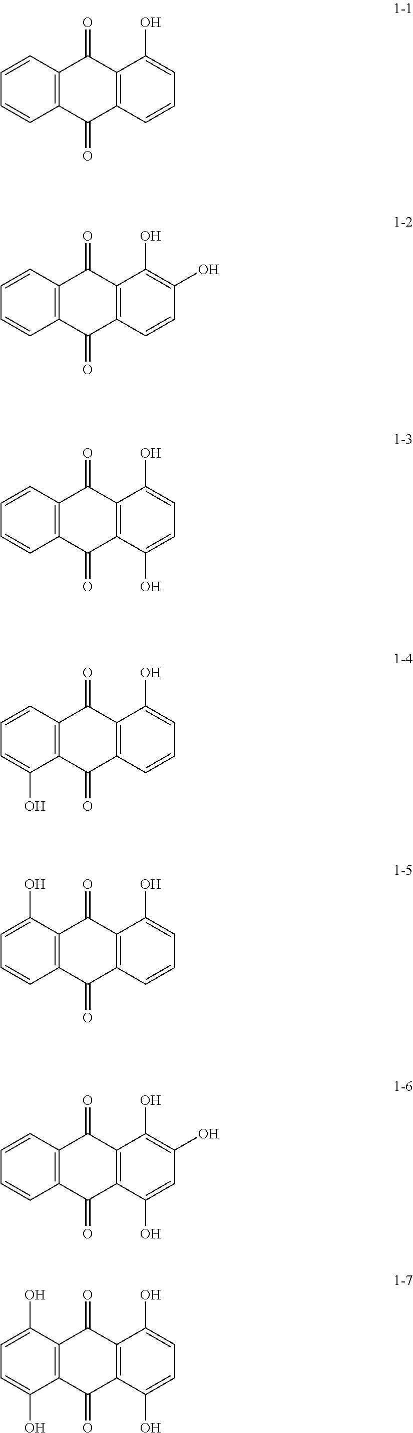

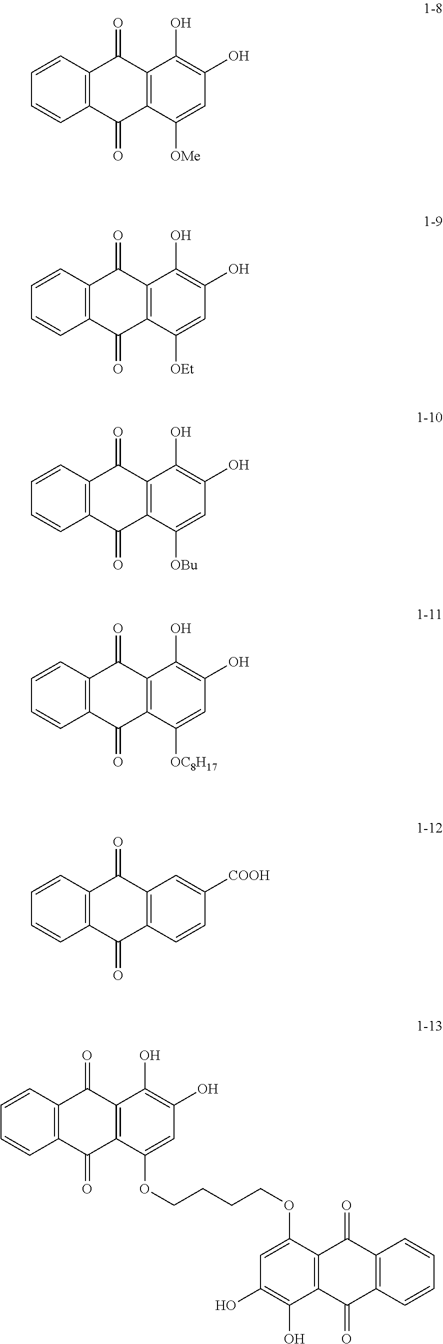

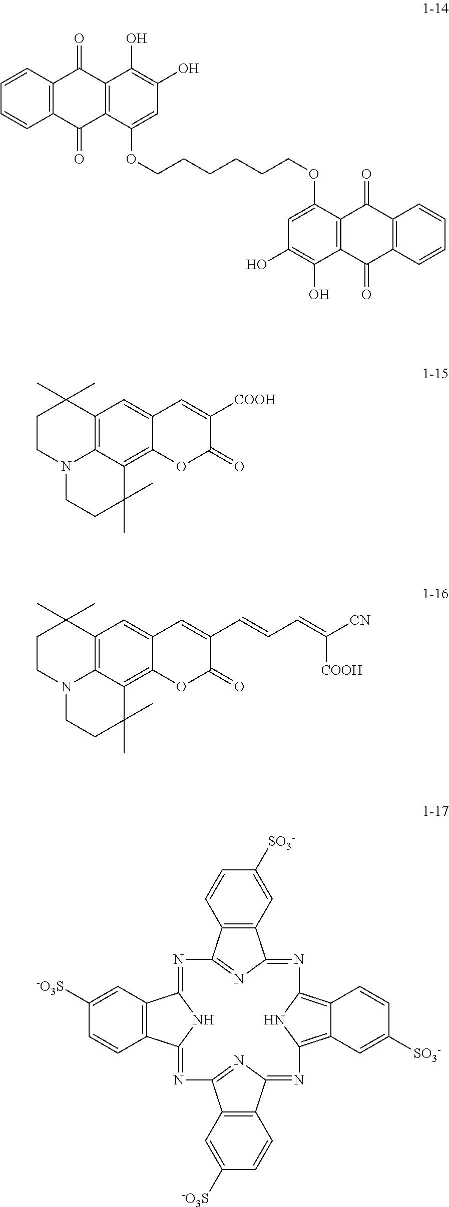

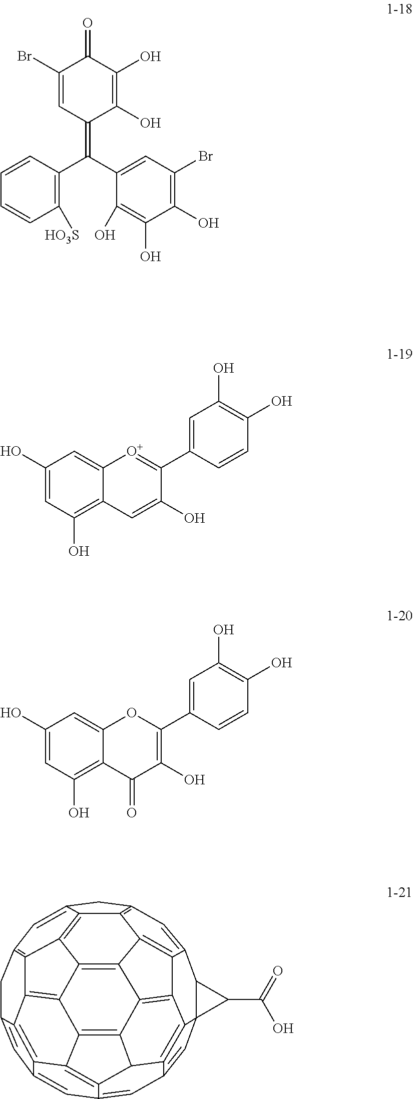 [SMILES: O=C1C(Br)=C/C(=C(\c2ccccc2S(=O)(=O)O)c2cc(Br)c(O)c(O)c2O)C(O)=C1O ; Oc1cc(O)c2cc(O)c(-c3ccc(O)c(O)c3)[o+]c2c1 ; O=c1c(O)c(-c2ccc(O)c(O)c2)oc2cc(O)cc(O)c12 ; O=C(O)C1C2c3cc4c5c6c(cc7c8c9c%10c(cc%11cc%12c%13c(c%14c%15c%16c(c3c5c%16c(c68)c%149)C3=C(C(=CC312)C=%12)C%13%15)c%11%10)C7)C4]

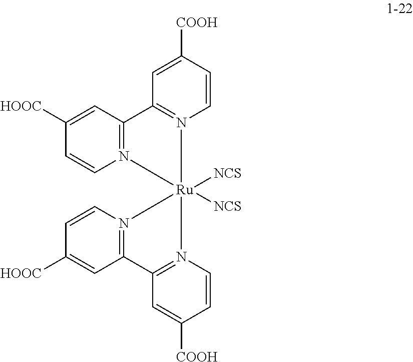

Examples of the method for attaching the electron-accepting compound onto the surfaces of the metal oxide particles include a dry method and a wet method.

The dry method is, for example, a method with which, while metal oxide particles are stirred with a mixer or the like having a large shear force, an electron-accepting compound as is or dissolved in an organic solvent is added dropwise or sprayed along with dry air or nitrogen gas so as to cause the electron-accepting compound to attach to the surfaces of the metal oxide particles. When the electron-accepting compound is added dropwise or sprayed, the temperature may be equal to or lower than the boiling point of the solvent. After the electron-accepting compound is added dropwise or sprayed, baking may be further conducted at 100° C. or higher. The temperature and time for baking are not particularly limited as long as the electrophotographic properties are obtained.

The wet method is, for example, a method with which, while metal oxide particles are dispersed in a solvent by stirring, ultrasonically, or by using a sand mill, an attritor, or a ball mill, the electron-accepting compound is added, followed by stirring or dispersing, and then the solvent is removed to cause the electron-accepting compound to attach to the surfaces of the metal oxide particles. The solvent is removed by, for example, filtration or distillation. After removing the solvent, baking may be further conducted at 100° C. or higher. The temperature and time for baking are not particularly limited as long as the electrophotographic properties are obtained. In the wet method, the moisture contained in the metal oxide particles may be removed before adding the electron-accepting compound. For example, the moisture may be removed by stirring and heating the metal oxide particles in a solvent or by boiling together with the solvent.

Attaching the electron-accepting compound may be conducted before, after, or simultaneously with the surface treatment of the metal oxide particles by a surface treatment agent.

The amount of the electron-accepting compound contained relative to the total solid content in the undercoat layer is, for example, 0.01 mass % or more and 20 mass % or less, may be 0.1 mass % or more and 10 mass % or less, or may be 0.5 mass % or more and 5 mass % or less.

When the amount of the electron-accepting compound contained is within the above-described range, the effects of the electron-accepting compound as the acceptor can be easily obtained compared to when the amount is below the range. Moreover, when the amount of the electron-accepting compound contained is within the above-described range, aggregation of the metal oxide particles and excessively uneven distribution of the metal oxide particles within the undercoat layer are less likely to occur compared to when the amount is beyond the range, and thus a rise in residual potential, occurrence of black dots, halftone density variation, and the like caused by excessively uneven distribution of the metal oxide particles are suppressed.

The amount of the electron-accepting compound contained relative to the total solid content in the undercoat layer may be 0.5 mass % or more and 2.0 mass % or less or may be 0.5 mass % or more and 1.0 mass % or less from the viewpoint of adjusting the electrostatic capacitance of the undercoat layer per unit area to be within the range described above.

### Additives in Undercoat Layer

The undercoat layer may further contain various additives.

For example, binder resin particles may be added as an additive. Examples of the binder resin particles include know materials such as silicone binder resin particles and crosslinking polymethyl methacrylate (PMMA) binder resin particles.

### Method for Forming Undercoat Layer

The undercoat layer may be formed by any known method. For example, a coating film is formed by using an undercoat-layer-forming solution prepared by adding the above-mentioned components to a solvent, dried, and, if needed, heated.

Examples of the solvent used for preparing the undercoat-layer-forming solution include known organic solvents, such as alcohol solvents, aromatic hydrocarbon solvents, halogenated hydrocarbon solvents, ketone solvents, ketone alcohol solvents, ether solvents, and ester solvents.

Specific examples of the solvent include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

When the undercoat layer contains inorganic particles, examples of the method for dispersing the inorganic particles in preparing the undercoat-layer-forming solution include known methods that use a roll mill, a ball mill, a vibrating ball mill, an attritor, a sand mill, a colloid mill, and a paint shaker.

Examples of the method for applying the undercoat-layer-forming solution to the conductive substrate include common methods such as a blade coating method, a wire bar coating method, a spray coating method, a dip coating method, a bead coating method, an air knife coating method, and a curtain coating method.

### Conductive Substrate

The electrophotographic photoreceptor includes a conductive substrate.

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. The term “conductive” means having a volume resistivity of less than 10¹³ Ω·cm.

The conductive substrate is, for example, a cylindrical hollow member and may be formed of a metal. Examples of the metal that constitutes the conductive substrate include pure metals such as aluminum, iron, and copper, and alloys such as stainless steel and aluminum alloys. The metal that constitutes the conductive substrate may be a metal that contains aluminum from the viewpoint of light-weightiness and excellent workability, and may be pure aluminum or an aluminum alloy. The aluminum alloy may be any alloy containing aluminum as a main component, and examples aluminum alloys include those that contain, in addition to aluminum, Si, Fe, Cu, Mn, Mg, Cr, Zn, or Ti. The “main component” here refers to an element that has the highest content (on a mass basis) among all of the elements contained in the alloy. From the viewpoint of workability, the metal that constitutes the conductive substrate may be a metal having an aluminum content (mass ratio) of 90.0% or more, 95.0% or more, or 99.0% or more.

The surface of the conductive substrate may be subjected to a known surface treatment, such as anodizing, pickling, or a Boehmite treatment.

The surface of the conductive substrate may be roughened to a center-line average roughness Ra of 0.04 μm or more and 0.5 μm or less in order to suppress interference fringes that occur when the electrophotographic photoreceptor used in a laser printer is irradiated with a laser beam. When incoherent light is used as a light source, there is no need to roughen the surface to prevent interference fringes, but roughening the surface suppresses generation of defects due to irregularities on the surface of the conductive substrate and thus is desirable for extending the lifetime.

Examples of the surface roughening method include a wet honing method with which an abrasive suspended in water is sprayed onto a conductive support, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodization film formed by anodization is chemically active as is, is prone to contamination, and has resistivity that significantly varies depending on the environment. Thus, a pore-sealing treatment may be performed on the porous anodization film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodization film may be, for example, 0.3 μm or more and 15 μm or less. When the thickness is within this range, a barrier property against injection tends to be exhibited, and the increase in residual potential caused by repeated use tends to be suppressed.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or higher and 48° C. or lower. The thickness of the film may be 0.3 μm or more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the film may be 0.1 μm or more and 5 μm or less. The Boehmite-treated body may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

### Intermediate Layer

Although not illustrated in the drawings, an intermediate layer may be further provided between the undercoat layer and the photosensitive layer.

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, urethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal elements such as zirconium, titanium, aluminum, manganese, and silicon.

These compounds used in the intermediate layer may be used alone, or two or more compounds may be used as a mixture or a polycondensation product.

In particular, the intermediate layer may be a layer that contains an organic metal compound that contains zirconium element or silicon element.

The intermediate layer may be formed by any known method. For example, a coating film is formed by using an intermediate-layer-forming solution prepared by adding the above-mentioned components to a solvent, dried, and, if needed, heated.

Examples of the application method for forming the intermediate layer include common methods such as a dip coating method, a lift coating method, a wire bar coating method, a spray coating method, a blade coating method, a knife coating method, and a curtain coating method.

The thickness of the intermediate layer may be set within the range of, for example, 0.1 μm or more and 3 μm or less. The intermediate layer may be used as the undercoat layer.

### Photosensitive Layer

### Charge Generating Layer

The charge generating layer is, for example, a layer that contains a charge generating material and a binder resin. The charge generating layer may be a vapor deposited layer of a charge generating material. The vapor deposited layer of the charge generating material may be used when an incoherent light such as a light emitting diode (LED) or an organic electro-luminescence (EL) image array is used.

Examples of the charge generating material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, in order to be compatible to the near-infrared laser exposure, a metal phthalocyanine pigment or a metal-free phthalocyanine pigment may be used as the charge generating material. Specific examples thereof include hydroxygallium phthalocyanine, chlorogallium phthalocyanine, dichlorotin phthalocyanine, and titanyl phthalocyanine.

In order to be compatible to the near ultraviolet laser exposure, the charge generating material may be a fused-ring aromatic pigment such as dibromoanthanthrone, a thioindigo pigment, a porphyrazine compound, zinc oxide, trigonal selenium, a bisazo pigment.

When an incoherent light source, such as an LED or an organic EL image array having an emission center wavelength in the range of 450 nm or more and 780 nm or less, is used, the charge generating material described above may be used; however, from the viewpoint of the resolution, when the photosensitive layer is as thin as 20 μm or less, the electric field intensity in the photosensitive layer is increased, charges injected from the substrate are decreased, and image defects known as black spots tend to occur. This is particularly noticeable when a charge generating material, such as trigonal selenium or a phthalocyanine pigment, that is of a p-conductivity type and easily generates dark current is used.

In contrast, when an n-type semiconductor, such as a fused-ring aromatic pigment, a perylene pigment, or an azo pigment, is used as the charge generating material, dark current rarely occurs and, even when the thickness is small, image defects known as black spots can be suppressed.

Whether n-type or not is determined by a time-of-flight method commonly employed, on the basis of the polarity of the photocurrent flowing therein. A material in which electrons flow more smoothly as carriers than holes is determined to be of an n-type.

The binder resin used in the charge generating layer is selected from a wide range of insulating resins. Alternatively, the binder resin may be selected from organic photoconductive polymers, such as poly-N-vinylcarbazole, polyvinyl anthracene, polyvinyl pyrene, and polysilane.

Examples of the binder resin include, polyvinyl butyral resins, polyarylate resins (polycondensates of bisphenols and aromatic dicarboxylic acids etc.), polycarbonate resins, polyester resins, phenoxy resins, vinyl chloride-vinyl acetate copolymers, acrylic resins, polyvinyl pyridine resins, cellulose resins, urethane resins, epoxy resins, casein, polyvinyl alcohol resins, and polyvinyl pyrrolidone resins. Here, “insulating” means having a volume resistivity of 10¹³ Ω·cm or more.

These binder resins are used alone or in combination as a mixture.

The blend ratio of the charge generating material to the binder resin may be in the range of 10:1 to 1:10 on a mass ratio basis.

The charge generating layer may contain other known additives.

The charge generating layer may be formed by any known method. For example, a coating film is formed by using an charge-generating-layer-forming solution prepared by adding the above-mentioned components to a solvent, dried, and, if needed, heated. The charge generating layer may be formed by vapor-depositing a charge generating material. The charge generating layer may be formed by vapor deposition particularly when a fused-ring aromatic pigment or a perylene pigment is used as the charge generating material.

Specific examples of the solvent for preparing the charge-generating-layer-forming solution include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination as a mixture.

The method for dispersing particles (for example, the charge generating material) in the charge-generating-layer-forming solution can use a media disperser such as a ball mill, a vibrating ball mill, an attritor, a sand mill, or a horizontal sand mill, or a media-less disperser such as stirrer, an ultrasonic disperser, a roll mill, or a high-pressure homogenizer. Examples of the high-pressure homogenizer include a collision-type homogenizer in which the dispersion in a high-pressure state is dispersed through liquid-liquid collision or liquid-wall collision, and a penetration-type homogenizer in which the fluid in a high-pressure state is caused to penetrate through fine channels.

In dispersing, it is effective to set the average particle diameter of the charge generating material in the charge-generating-layer-forming solution to 0.5 μm or less, 0.3 μm or less, or 0.15 μm or less.

Examples of the method for applying the charge-generating-layer-forming solution to the undercoat layer (or the intermediate layer) include common methods such as a blade coating method, a wire bar coating method, a spray coating method, a dip coating method, a bead coating method, an air knife coating method, and a curtain coating method.

The thickness of the charge generating layer may be set within the range of, for example, 0.1 μm or more and 5.0 μm or less, or with in the range of 0.2 μm or more and 2.0 μm or less.

### Charge Transporting Layer

The charge transporting layer is, for example, a layer that contains a charge transporting material and a binder resin. The charge transporting layer may be a layer that contains a polymer charge transporting material.

Examples of the charge transporting material include electron transporting compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the charge transporting material include hole transporting compounds such as triarylamine compounds, benzidine compounds, aryl alkane compounds, aryl-substituted ethylene compounds, stilbene compounds, anthracene compounds, and hydrazone compounds. These charge transporting materials may be used alone or in combination, but are not limiting.

From the viewpoint of charge mobility, the charge transporting material may be a triaryl amine derivative represented by structural formula (a-1) below or a benzidine derivative represented by structural formula (a-2) below.

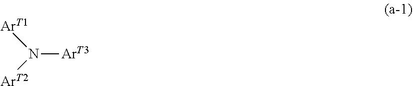

In structural formula (a-1), Ar^{T1}, Ar^{T2}, and Ar^{T3} each independently represent a substituted or unsubstituted aryl group, —C₆H₄—C(RT4)═C(R^{T5}) (R^{T6}), or —C₆H₄—CH═CH—CH═C (R^{T7}) (R^{T8}). R^{T4}, R^{T5}, R^{T6}, R^{T7}, and R^{T8} each independently represent hydrogen element, a substituted or unsubstituted alkyl group, or a substituted or unsubstituted aryl group.

Examples of the substituent for each of the groups described above include halogen element, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

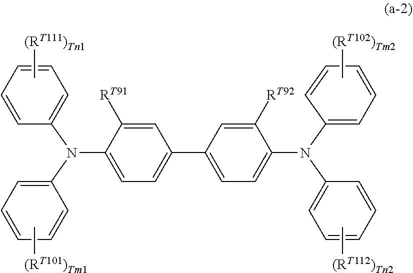

In structural formula (a-2), R^{T91} and R^{T92} each independently represent hydrogen element, halogen element, an alkyl group having 1 to 5 carbon atoms, or an alkoxy group having 1 to 5 carbon atoms. R^{T101}, R^{T102}, R^{T111}, and R^{T112} each independently represent halogen element, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R^{T12})═C(R^{T13}) (R^{T14}), or —CH═CH—CH═C(R^{T15}) (R^{T16}); and R^{T12}, R^{T13}, R^{T14}, R^{T15}, and R^{T16} each independently represent hydrogen element, a substituted or unsubstituted alkyl group, or a substituted or unsubstituted aryl group. Tm1, Tm2, Tn1, and Tn2 each independently represent an integer of 0 or more and 2 or less.

Examples of the substituent for each of the groups described above include halogen element, an alkyl group having 1 to 5 carbon atoms, and an alkoxy group having 1 to 5 carbon atoms. Examples of the substituent for each of the groups described above include a substituted amino group substituted with an alkyl group having 1 to 3 carbon atoms.

Among the triarylamine derivatives represented by structural formula (a-1) and the benzidine derivatives represented by structural formula (a-2) above, a triarylamine derivative having —C₆H₄—CH═CH—CH═C(R^{T7}) (R^{T8}) or a benzidine derivative having —CH═CH—CH═C(R^{T15}) (R^{T16}) may be used from the viewpoint of the charge mobility.

Examples of the polymer charge transporting material that can be used include known charge transporting materials such as poly-N-vinylcarbazole and polysilane. In particular, polyester polymer charge transporting materials may be used. The polymer charge transporting material may be used alone or in combination with a binder resin.

Examples of the binder resin used in the charge transporting layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. Among these, a polycarbonate resin or a polyarylate resin may be used as the binder resin. These binder resins are used alone or in combination.

The blend ratio of the charge transporting material to the binder resin may be in the range of 10:1 to 1:5 on a mass ratio basis.

The charge transporting layer may contain other known additives.

The charge transporting layer may be formed by any known method. For example, a coating film is formed by using an charge-transporting-layer-forming solution prepared by adding the above-mentioned components to a solvent, dried, and, if needed, heated.

Examples of the solvent used to prepare the charge-transporting-layer-forming solution include common organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the charge-transporting-layer-forming solution to the charge generating layer include common methods such as a blade coating method, a wire bar coating method, a spray coating method, a dip coating method, a bead coating method, an air knife coating method, and a curtain coating method.

The thickness of the charge transporting layer may be set within the range of, for example, 5 μm or more and 50 μm or less, or within the range of 10 μm or more and 30 μm or less.

### Protective Layer

A protective layer is disposed on a photosensitive layer if necessary. The protective layer is, for example, formed to avoid chemical changes in the photosensitive layer in a charged state and further improve the mechanical strength of the photosensitive layer.

Thus, the protective layer may be a layer formed of a cured film (crosslinked film). Examples of such a layer include layers indicated in 1) and 2) below.

1) A layer formed of a cured film of a composition that contains a reactive-group-containing charge transporting material having a reactive group and a charge transporting skeleton in the same molecule (in other words, a layer that contains a polymer or crosslinked body of the reactive-group-containing charge transporting material).

2) A layer formed of a cured film of a composition that contains a non-reactive charge transporting material, and a reactive-group-containing non-charge transporting material that does not have a charge transporting skeleton but has a reactive group (in other words, a layer that contains a polymer or crosslinked body of the non-reactive charge transporting material and the reactive-group-containing non-charge transporting material).

Examples of the reactive group contained in the reactive-group-containing charge transporting material include chain-polymerizable groups, an epoxy group, —OH, —OR (where R represents an alkyl group), —NH₂, —SH, —COOH, and —SiR^{Q1}_{3-Qn} (OR^{Q2})_{Qn} (where R^{Q1} represents hydrogen element, an alkyl group, or a substituted or unsubstituted aryl group, R^{Q2} represents hydrogen element, an alkyl group, or a trialkylsilyl group, and Qn represents an integer of 1 to 3).

The chain-polymerizable group may be any radical-polymerizable functional group, and an example thereof is a functional group having a group that contains at least a carbon-carbon double bond. A specific example thereof is a group that contains at least one selected from a vinyl group, a vinyl ether group, a vinyl thioether group, a vinylphenyl group, an acryloyl group, a methacryloyl group, and derivatives thereof. Among these, the chain-polymerizable group may be a group that contains at least one selected from a vinyl group, a vinylphenyl group, an acryloyl group, a methacryloyl group, and derivatives thereof due to their excellent reactivity.

The charge transporting skeleton of the reactive-group-containing charge transporting material may be any known structure used in the electrophotographic photoreceptor, and examples thereof include skeletons that are derived from nitrogen-containing hole transporting compounds, such as triarylamine compounds, benzidine compounds, and hydrazone compounds, and that are conjugated with nitrogen element. Among these, a triarylamine skeleton may be used.

The reactive-group-containing charge transporting material that has such a reactive group and a charge transporting skeleton, the non-reactive charge transporting material, and the reactive-group-containing non-charge transporting material may be selected from among known materials.

The protective layer may contain other known additives.

The protective layer may be formed by any known method. For example, a coating film is formed by using a protective-layer-forming solution prepared by adding the above-mentioned components to a solvent, dried, and, if needed, cured such as by heating.

Examples of the solvent used to prepare the protective-layer-forming solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents are used alone or in combination as a mixture.

The protective-layer-forming solution may be a solvent-free solution.

Examples of the application method used to apply the protective-layer-forming solution onto the photosensitive layer (for example, the charge transporting layer) include common methods such as a dip coating method, a lift coating method, a wire bar coating method, a spray coating method, a blade coating method, a knife coating method, and a curtain coating method.

The thickness of the protective layer may be set within the range of, for example, 1 μm or more and 20 μm or less, or within the range of 2 μm or more and 10 μm or less.

### Single-Layer-Type Photosensitive Layer

The single-layer-type photosensitive layer (charge generating/charge transporting layer) is, for example, a layer that contains a charge generating material, a charge transporting material, and, optionally, a binder resin and other known additives. These materials are the same as those described for the charge generating layer and the charge transporting layer.

The amount of the charge generating material contained in the single-layer-type photosensitive layer relative to the total solid content may be 0.1 mass % or more and 10 mass % or less, or may be 0.8 mass % or more and 5 mass % or less. The amount of the charge transporting material contained in the single-layer-type photosensitive layer relative to the total solid content may be 5 mass % or more and 50 mass % or less.

The method for forming the single-layer-type photosensitive layer is the same as the method for forming the charge generating layer and the charge transporting layer.

The thickness of the single-layer-type photosensitive layer may be, for example, 5 μm or more and 50 μm or less, or 10 μm or more and 40 μm or less.

### EXAMPLES

The present disclosure will now be described in further detail through Examples which do not limit the scope of the present disclosure. Unless otherwise noted, “parts” means “parts by mass”.

### Example 1

### Preparation of Undercoat Layer

One hundred parts by mass of zinc oxide (volume-average primary particle diameter: 70 nm, produced by Tayca Corporation, BET specific surface area: 15 m²/g) serving as metal oxide particles and 500 parts by mass of methanol are mixed by stirring, 1.25 parts by mass of KBM603 (produced by Shin-Etsu Chemical Co., Ltd.) serving as a silane coupling agent is added thereto, and the resulting mixture is stirred for 2 hours. Then, methanol is distilled away by vacuum distillation, baking is performed at 120° C. for 3 hours, and, as a result, zinc oxide particles surface-treated with a silane coupling agent are obtained.

A mixture is prepared by mixing 44.6 parts by mass of the zinc oxide particles surface-treated with a silane coupling agent, 0.45 parts by mass of hydroxyanthraquinone “Example Compound (1-1)” serving as an electron-accepting compound, 10.2 parts by mass of blocked isocyanate (Sumidur 3173 produced by Sumitomo Bayer Urethane Co., Ltd.) serving as a curing agent, 3.5 parts by mass of a butyral resin (trade name: S-LEC BM-1 produced by Sekisui Chemical Co., Ltd.), 0.005 parts by mass of dioctyltin dilaurate serving as a catalyst, and 41.3 parts by mass of methyl ethyl ketone, and is then dispersed in a sand mill with glass beads having a diameter of 1 mm for 3.9 hours (dispersing time: 3.9 hours), and a dispersion is obtained as a result. To the dispersion, 3.6 parts by mass of silicone resin particles (Tospearl 145 produced by Momentive Performance Materials Inc.) are added to obtain an undercoat-layer-forming solution. The viscosity of the undercoat-layer-forming solution at a coating temperature of 24° C. is 235 mPa·s.

The undercoat-layer-forming solution is applied to a conductive substrate (aluminum substrate, diameter: 30 mm, length: 357 mm, thickness: 1.0 mm) by a dip coating method at a coating speed of 220 mm/min, and the applied solution is dried and cured at 190° C. for 24 minutes to obtain an undercoat layer having a thickness of 19 μm.

### Preparation of Charge Generating Layer

A mixture containing 15 parts by mass of hydroxygallium phthalocyanine serving as a charge generating material and having diffraction peaks at least at Bragg's angles (2θ±0.2°)) of 7.3°, 16.0°, 24.9°, and 28.0° in an X-ray diffraction spectrum obtained by using CuKα X-ray, 10 parts by mass of a vinyl chloride-vinyl acetate copolymer binder resin (VMCH produced by Nippon Unicar Company Limited) serving as a binder resin, and 200 parts by mass of n-butyl acetate is stirred and dispersed in a sand mill with glass beads having a diameter ϕ of 1 mm for 4 hours. To the resulting dispersion, 175 parts by mass of n-butyl acetate and 180 parts by mass of methyl ethyl ketone are added and stirred so as to obtain a charge-generating-layer-forming solution. This charge-generating-layer-forming solution is applied to the undercoat layer by dip coating. Subsequently, the applied solution is dried at 140° C. for 10 minutes to form a charge generating layer having a thickness of 0.2 μm.

### Preparation of Charge Transporting Layer

To 800 parts by mass of tetrahydrofuran, 40 parts by mass of a charge transporting agent (HT-1), 8 parts by mass of a charge transporting agent (HT-2), and 52 parts by mass of a polycarbonate binder resin (A) (viscosity-average molecular weight: 50,000) are added and dissolved, 8 parts by mass of tetraethylene fluoride binder resin (Lubron L5 produced by Daikin Industries Ltd., average particle diameter: 300 nm) is added, and the resulting mixture is dispersed for 2 hours by using a homogenizer (ULTRA-TURRAX T50 produced by IKA Japan) at 5500 rpm to obtain a charge-transporting-layer-forming solution.

The solution is applied to the charge generating layer. Subsequently, the applied solution is dried at 140° C. for 40 minutes to form a charge transporting layer having a thickness of 35 μm. The resulting product is used as the electrophotographic photoreceptor.

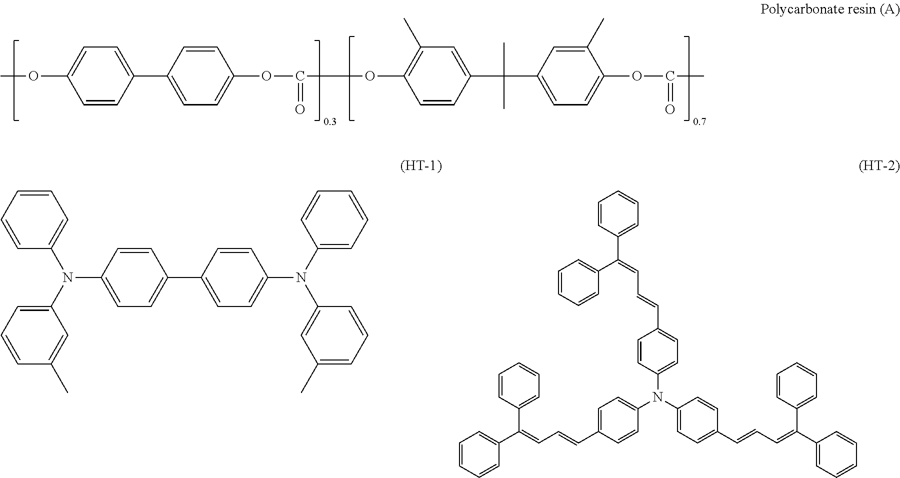

The electrophotographic photoreceptor obtained as above is mounted onto a modified model obtained by removing a charge erasing member from an image forming apparatus (DC-IVC5570 produced by Fuji Xerox Co., Ltd.), and this modified model is used as the image forming apparatus.

### Examples 2 to 6 and Comparative Examples 1 to 2

Image forming apparatuses are obtained as in Example 1 except that, in preparing the undercoat layer, the dispersing time, the type of the metal oxide particles, the type of the binder resin, and the metal element abundance ratio are as indicated in Table. In Table, “Dispersing time” refers to the time for which dispersing is performed in the step of preparing the undercoat layer.

### Example 7

An image forming apparatus is obtained as in Example 1 except that the material and amount of the binder resin are changed to a “phenolic resin (WR-103 produced by DIC Corporation)” and 40 parts by mass and the solvent to “cyclohexanone (FUJIFILM Wako Pure Chemical Corporation)” and 60 parts by mass in the step of preparing the undercoat layer.

### Evaluation of Ghost

A halftone mage having an area coverage of 100% is output on one A4 sheet of paper by using each one of the image forming apparatuses in an environment of 28° C. in temperature and 85% in humidity. Next, a 20 mm×20 mm image is output, and then an A4 halftone image (all halftone cyan image) having an area coverage of 30% is output on one sheet continuously. The density fluctuation derived from the 20 mm×20 mm image on the halftone mage after one round of the electrophotographic photoreceptor is evaluated with naked eye. The evaluation standard is as follows, and the results are indicated in Table. A and B are acceptable.

### Evaluation of Ghost

A: No density fluctuations.
B: Slight density fluctuations.
C: Clear density fluctuations.

### Evaluation of Image Density Non-Uniformity

A halftone mage having an image density of 30% is output on one A3 sheet of paper by using each image forming apparatus in an environment of 10° C. in temperature and 15% in humidity. The density fluctuation derived is evaluated with naked eye within a range of one round of the electrophotographic photoreceptor. The evaluation standard is as follows, and the results are indicated in Table. A and B are acceptable.

### Evaluation Standard of Density Non-Uniformity

A: No density fluctuations.
B: Slight density fluctuations.
C: Clear density fluctuations.

TABLE

| | | | | Metal | Evaluation | |
|---|---|---|---|---|---|---|
| | | | | element | | Density |
| | Metal oxide | | Dispersing | abundance | | non- |
| | particles | Binder resin | time (hr) | ratio (%) | Ghost | uniformity |
| Example 1 | Zinc oxide | Urethane | 3.9 | 4 | B | B |
| | particles | binder resin | | | | |
| Example 2 | Zinc oxide | Urethane | 0.7 | 16 | B | B |
| | particles | binder resin | | | | |
| Example 3 | Zinc oxide | Urethane | 3.6 | 5.2 | A | A |
| | particles | binder resin | | | | |
| Example 4 | Zinc oxide | Urethane | 1.3 | 14 | A | A |
| | particles | binder resin | | | | |
| Example 5 | Titanium | Urethane | 3.9 | 4 | B | B |
| | oxide | binder resin | | | | |
| | particles | | | | | |
| Example 6 | Tin oxide | Urethane | 3.9 | 4 | B | B |
| | particles | binder resin | | | | |
| Example 7 | Zinc oxide | Phenolic | 3.9 | 4 | B | B |
| | particles | resin | | | | |
| Comparative | Zinc oxide | Urethane | 4 | 3.7 | C | B |
| Example 1 | particles | binder resin | | | | |
| Comparative | Zinc oxide | Urethane | 0.2 | 18 | A | C |
| Example 2 | particles | binder resin | | | | |

The results described above indicate that, compared to the image forming apparatuses of Comparative Examples 1 and 2, the image forming apparatuses of Examples 1 to 7 suppress ghost and occurrence of image density non-uniformity when images are formed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an electrophotographic photoreceptor including
a conductive substrate,
an undercoat layer containing a binder resin and metal oxide particles and being disposed on the conductive substrate, and
a photosensitive layer disposed on the undercoat layer;
a charging unit that charges a surface of the electrophotographic photoreceptor;
an electrostatic latent image-forming unit that forms an electrostatic latent image on the charged surface of the electrophotographic photoreceptor;
a developing unit that develops the electrostatic latent image on the surface of the electrophotographic photoreceptor by using a developer containing a toner so as to form a toner image; and
a transfer unit that transfers the toner image onto a surface of a transfer-receiving member,
but not comprising a charge erasing member that erases charges on the surface of the electrophotographic photoreceptor,
wherein a metal element abundance ratio determined by X-ray photoelectron spectroscopy at a surface of the undercoat layer on which the photosensitive layer is formed is 3.8% or more and 17% or less relative to a carbon element abundance determined by X-ray photoelectron spectroscopy at the surface of the undercoat layer on which the photosensitive layer is formed.

2. The image forming apparatus according to claim 1, wherein the metal element abundance ratio is 4.0% or more relative to the carbon element abundance.

3. The image forming apparatus according to claim 1, wherein the metal element abundance ratio is 5.0% or more relative to the carbon element abundance.

4. The image forming apparatus according to claim 1, wherein the metal element abundance ratio is 17% or less relative to the carbon element abundance.

5. The image forming apparatus according to claim 1, wherein the metal element abundance ratio is 15.5% or less relative to the carbon element abundance.

6. The image forming apparatus according to claim 1, wherein the metal element abundance ratio is 5.0% or more and 15% or less relative to the carbon element abundance.

7. The image forming apparatus according to claim 1, wherein the undercoat layer contains at least one type of metal oxide particles selected from the group consisting of zinc oxide particles, titanium oxide particles, and tin oxide particles.

8. The image forming apparatus according to claim 7, wherein the metal oxide particles are zinc oxide particles.

9. The image forming apparatus according to claim 1, wherein an amount of the metal oxide particles contained relative to the undercoat layer is 10 mass % or more and 85 mass % or less.

10. The image forming apparatus according to claim 1, wherein the binder resin is at least one selected from the group consisting of a phenolic resin, a melamine resin, a guanamine resin, and a urethane resin.

11. A process cartridge detachably attachable to an image forming apparatus, the process cartridge comprising:
an electrophotographic photoreceptor including
a conductive substrate,
an undercoat layer disposed on the conductive substrate, and
a photosensitive layer disposed on the undercoat layer,
but not comprising a charge erasing member that erases charges on the surface of the electrophotographic photoreceptor,
wherein a metal element abundance ratio determined by X-ray photoelectron spectroscopy at a surface of the undercoat layer on which the photosensitive layer is formed is 3.8% or more and 17% or less relative to a carbon element abundance determined by X-ray photoelectron spectroscopy at the surface of the undercoat layer on which the photosensitive layer is formed.

12. The process cartridge according to claim 11, wherein the metal element abundance ratio is 4.0% or more relative to the carbon element abundance.

13. The process cartridge according to claim 11, wherein the metal element abundance ratio is 5.0% or more relative to the carbon element abundance.

14. The process cartridge according to claim 11, wherein the metal element abundance ratio is 17% or less relative to the carbon element abundance.

15. The process cartridge according to claim 11, wherein the metal element abundance ratio is 15.5% or less relative to the carbon element abundance.

16. The process cartridge according to claim 11, wherein the metal element abundance ratio is 5.0% or more and 15% or less relative to the carbon element abundance.

17. The process cartridge according to claim 11, wherein the undercoat layer contains at least one type of metal oxide particles selected from the group consisting of zinc oxide particles, titanium oxide particles, and tin oxide particles.

18. The process cartridge according to claim 17, wherein the metal oxide particles are zinc oxide particles.

19. The process cartridge according to claim 11, wherein an amount of the metal oxide particles contained relative to the undercoat layer is 10 mass % or more and 85 mass % or less.

20. The process cartridge according to claim 11, wherein the binder resin is at least one selected from the group consisting of a phenolic resin, a melamine resin, a guanamine resin, and a urethane resin.
